(19) United States
(12) Patent Application Publication
(10) Pub. No.: US 2008/0243602 A1
(43) Pub. Date: Oct. 2, 2008

(54) SYSTEMS AND METHODS FOR PROVIDING IPTV ADVERTISEMENTS

(75) Inventor: George Foti, Dollard des Ormeaux (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/692,803

(22) Filed: Mar. 28, 2007

(51) Int. Cl. G06Q 30/00

(52) U.S. Cl. 705/14

(57) ABSTRACT

Systems and methods according to the exemplary embodiments provide advertisements to end users in IPTV systems. IMS core networks can be used to provide the advertisements, via an IP network, to an IPTV client. An ad server can subscribe to a service which notifies it when a targeted user or users are online and inform it regarding an IPTV end user equipment that is currently being used. Then, a personalized advertisement can be forwarded to that IPTV end user equipment for rendering.

### TECHNICAL FIELD

The present invention relates generally to communications systems and in particular to methods and systems for providing IPTV advertisements in communications systems.

### BACKGROUND

As the level of technology increases, the options for communications have become more varied. For example, in the last 30 years in the telecommunications industry, personal communications have evolved from a home having a single rotary dial telephone, to a home having multiple telephone, cable and/or fiber optic lines that accommodate both voice and data. Additionally cellular phones and Wi-Fi have added a mobile element to communications. Similarly, in the entertainment industry, 30 years ago there was only one format for television and this format was transmitted over the air and received via antennas located at a home. This has evolved into both different standards of picture quality such as, standard definition TV (SDTV), enhanced definition TV (EDTV) and high definition TV (HDTV), and more systems for delivery of these different television display formats such as cable and satellite. Additionally, services have grown to become overlapping between these two industries. As these systems continue to evolve in both industries, the service offerings will continue to merge and new services can be expected to be available for a consumer. Also these services will be based on the technical capability to process and output more information, for example as seen in the improvements in the picture quality of programs viewed on televisions, and therefore it is expected that service delivery requirements will continue to rely on more bandwidth being available throughout the network including the “last mile” to the end user.

Another related technology that impacts both the communications and entertainment industries is the Internet. The physical structure of the Internet and associated communication streams have also evolved to handle an increased flow of data. Servers have more memory than ever before, communications links exist that have a higher bandwidth than in the past, processors are faster and more capable and protocols exist to take advantage of these elements. As consumers' usage of the Internet grows, service companies have turned to the Internet (and other IP networks) as a mechanism for providing traditional services. These multimedia services can include Internet Protocol television (IPTV, referring to systems or services that deliver television programs over a network using IP data packets), video on demand (VOD), voice-over-IP (VoIP), and other web related services.

To accommodate the new and different ways in which IP networks are being used to provide various services, new network architectures are being developed and standardized. One such development is the Internet Protocol Multimedia Subsystem (IMS). IMS is an architectural framework which uses a plurality of Internet Protocols (IP) for delivering IP multimedia services to an end user. A goal of IMS is to assist in the delivery of these services to an end user by having a horizontal control layer which separates the service layer and the access layer. More details regarding IMS architectures are provided below.

It would be desirable to provide methods and systems for advertising to users who are accessing IPTV services via an IMS system.

### SUMMARY

According to one exemplary embodiment a method for providing advertisements from an ad server to an IPTV end user via an IMS network includes alerting the ad server when the IPTV end user is online, receiving, at the ad server, information which identifies an IPTV equipment which the IPTV end user is currently using, and forwarding, in response to the alert and the information, an advertisement selected for the IPTV end user to the IPTV equipment.

According to another exemplary embodiment a communication system includes an ad server including: a processor for receiving an alert indicating when an IPTV end user is online and information which identifies an IPTV equipment which the IPTV end user is currently using, and a memory device for storing one of an advertisement for the IPTV end user and a reference to the advertisement, wherein said processor forwards, in response to the alert and the information, one of the advertisement and the reference to the IPTV equipment.

According to yet another exemplary embodiment a computer-readable medium contains instructions which, when executed on a computer, perform the steps of alerting an ad server when an IPTV end user is online, receiving, at the ad server, information which identifies an IPTV equipment which the IPTV end user is currently using, and forwarding, in response to the alert and the information, an advertisement selected for the IPTV end user to the IPTV equipment.

### BRIEF DESCRIPTION OF THE DRAWINGS

The accompanying drawings illustrate exemplary embodiments, wherein:

FIG. 1(a) illustrates a communication system according to an exemplary embodiment;

FIG. 1(b) illustrates an exemplary IPTV portion of the communication system of FIG. 1(a) in more detail;

FIG. 2 illustrates an exemplary IMS portion of the communication system of FIG. 1(a) in more detail;

FIG. 3 is a signaling diagram illustrating systems and methods for providing IPTV advertisements according to an exemplary embodiment;

FIG. 4 is a signaling diagram illustrating systems and methods for providing IPTV advertisements according to another exemplary embodiment;

FIG. 5 is a signaling diagram illustrating systems and methods for providing IPTV advertisements according to yet another exemplary embodiment;

FIG. 6 is an ad server according to an exemplary embodiment;

FIG. 7 is a flowchart illustrating an exemplary method for providing an IPTV advertisement according to still another exemplary embodiment.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

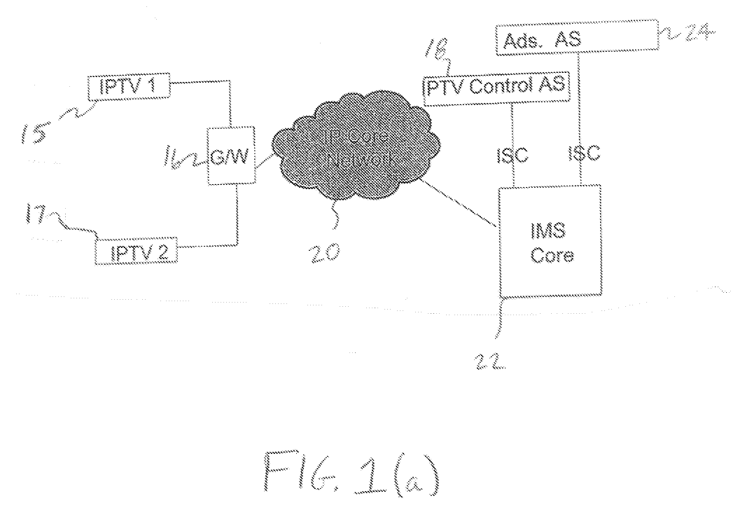

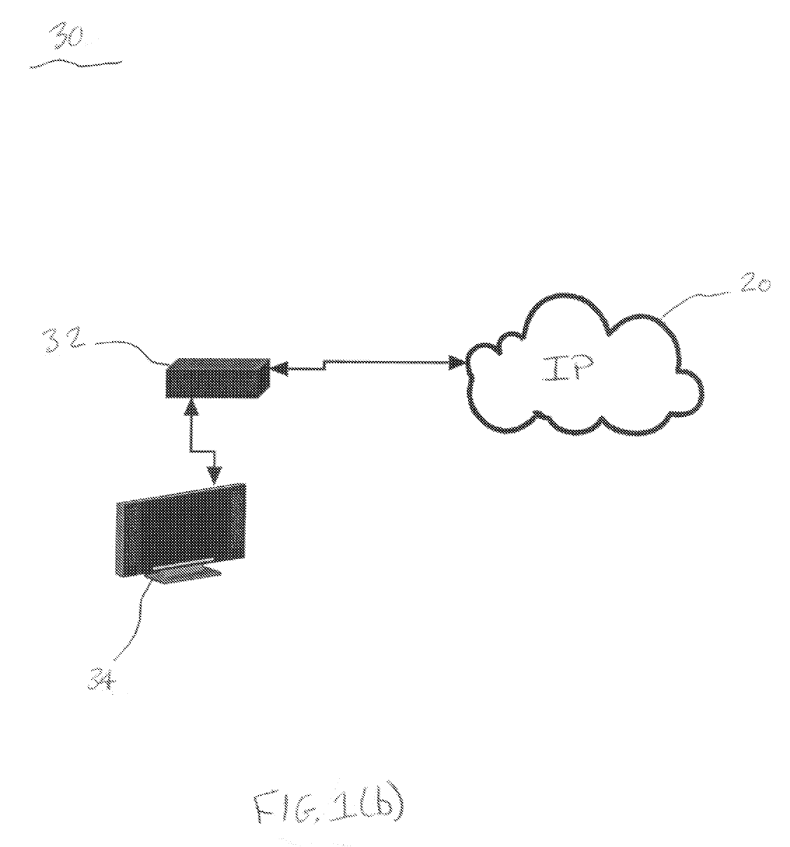

In order to provide some context for this discussion, FIG. 1(a) illustrates an exemplary communications network 10 in which these exemplary embodiments can be implemented. Therein, two exemplary IPTV end user equipments 15 and 17, e.g., televisions and/or set-top boxes, are connected to the network 10 via a gateway or access router 16. IPTV communications between the end user equipments 15 and 17 and the IPTV control application server 18 are provided via an IP core network 20, e.g., potentially including the Internet, and an IMS core network 22. An ad server 24 is also connected to the IMS core network 22 via the IMS Service Control (ISC) interface

IPTV is a service which provides digital television signals delivered using IP over a network structure (such as IMS) and may be combined with telephone services (such as VoIP), web access and VoD. An exemplary user side of an IPTV system in which advertisements may be rendered according to these exemplary embodiments will now be described as shown in FIG. 1(b). The IPTV system 30 includes a web TV 34, a set-top box 32 and an IP network 20. The web TV 34 is capable of displaying a variety of video signals and can also be used for voice communications, in particular web TV 34 is capable of receiving signals using IP protocols either directly or via set-top box 32. Set-top box 32 typically acts to control inputs to web TV 34 and set-top box 32 can contain a removable smart card (not shown) such as an IP multimedia services identity module (ISIM) application on a universally integrated circuit card (UICC) and is in communications with both web TV 34 and IP network 20. The UICC contains memory within which security information and applications can be stored.

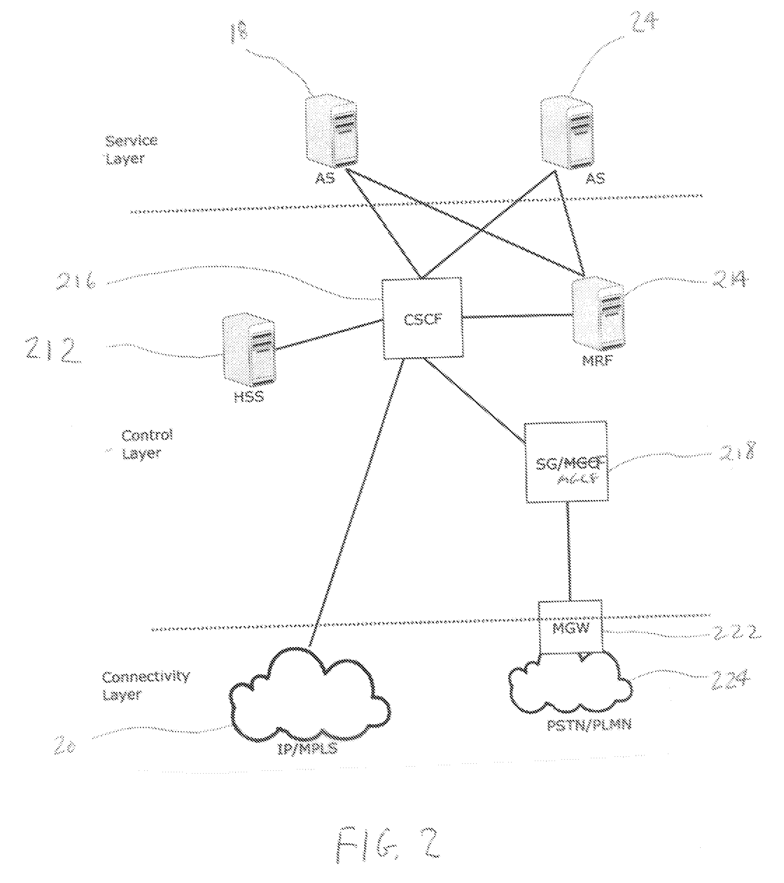

Connecting the ad server 24 to the IP core network 20 via an IMS core network 22 enables systems and methods according to these exemplary embodiments to utilize reachability features available in IMS systems to (a) determine when a particular user or users are online and (b) identify a particular piece of IPTV equipment which that user is currently viewing to determine when and where to send personalized advertisements through the network to those targeted end user(s). Thus a further discussion of an IMS core network 22 with which exemplary embodiments can be implemented will now be described with respect to FIG. 2.

Therein, from an architectural point of view, IMS systems can be broken down into three layers: (1) a service layer, (2) a control layer, and (3) a connectivity layer. The service layer contains application servers (ASs) which contain services and applications that can be delivered to an end user, e.g., Internet Protocol Television (IPTV) services via server 18 and advertisement services via server 24. The control layer describes the IMS core network 22 and contains, among other elements, a home subscriber server (HSS) 212, a media resource function (MRF) 214, a call service control function (CSCF) 216, a signaling gateway/media gateway control function (SG/MGCF) 218 and a media gateway 222. These elements in the control layer are typically used for managing session set-up, resource modification and release of resources. The connectivity layer includes routers and switches used in both the backbone network and the access network. These elements are shown by Internet Protocol (IP)/multi-protocol label switching (MPLS) 20, the public switched telephone network (PSTN)/public land mobile network (PLMN) 224 and media gateway 222.

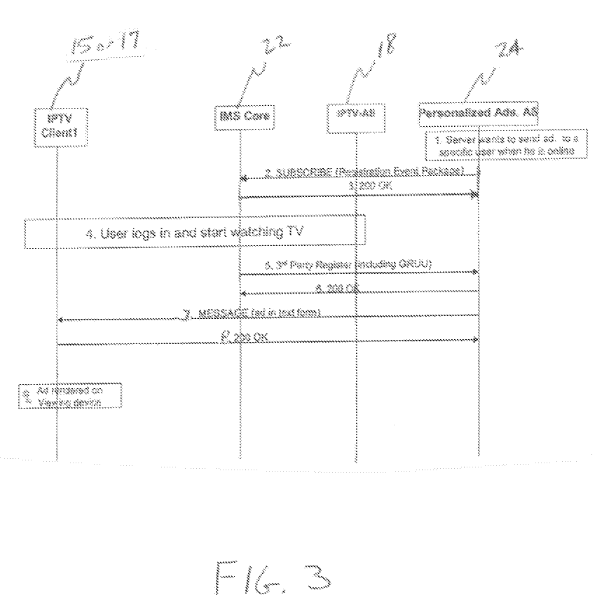

Using the previously described IP and IMS architectures shown in FIGS. 1 and 2, an end user should preferably be able to access a multitude of applications and service providers through a single access point. For example, a user may want to watch an IPTV show on one television, record a movie for future use on a recorder, and have streaming audio playing in another room all of which are provided via a single access point. At the same time, service providers would like to be able to supply personalized advertisements along with, for example, an IPTV viewer's currently requested programming. Exemplary embodiments for providing such advertisement services via the IP/IMS architectures described above will now be discussed starting with reference to the signaling diagram of FIG. 3.

Therein, starting at the top of the figure, the ad server 24 first determines that it wants to send a particular advertisement to a specific user when he or she is “online”, i.e., accessing a particular service, such as IPTV. Any desired mechanism can be employed by ad server 24 for making this determination. In order to be informed when the specific user is online, the ad server 24 issues a SUBSCRIBE message to the registration event package for the target user (signal 2), which subscribe message is transmitted to the IMS core 22 and, more specifically, to the serving CSCF 216 which handles the registration event package. Through this subscription, the ad server 24 will be notified when the user registers in the IMS domain. It will be appreciated that, although these exemplary embodiments refer to interactions with individual users, the present invention is not so limited and can be applied to, e.g., groups of users that are targeted for receiving a particular advertisement. In addition, the ad server 24 by requesting this subscription, the ad server 24 will also be informed of the globally routable user agent URI (GRUU) associated with the identified end user when that user registers with the IMS core 22. The GRUU enables the ad server 24 to target the ad precisely to the end point (IPTV equipment or client) where the targeted end user is currently logged on. The ad server 24 will receive an acknowledgement signal (“200 OK”, signal 3) in response to its SUBSCRIBE message.

At some point in time, the targeted end user will register in the IMS domain (step 4 in FIG. 3) when she or he starts watching an IPTV program on his or her IPTV device. The ad server 24 is informed of this event by receipt of a 3^{rd} Party Register message (signal 5 in FIG. 3), which 3^{rd} Party Register message will also include the GRUU and which can be transmitted from the IMS core network 22, e.g., from the serving CSCF 216. The ad server 24 can acknowledge the 3^{rd} Party Register message via a “200 OK” message (signal 6 in FIG. 3). Then, according to this exemplary embodiment, the ad server 24 can supply the advertisement directly to the end user device identified by the GRUU (signal 7) as, for example, an ad in text format through the IP/IMS network. For example, this message can be a SIP (Session Initiated Protocol) message which uses the GRUU as its Request URI (R-URI). SIP is a transaction-oriented, text-based protocol for which more information can be found in the standards document referred to as “RFC 3261, SIP: Session Initiation Protocol”, promulgated by the Network Working Group and downloadable at http://www.ietf.org/rfc/rfc3261.txt. The message supplying the advertisement can also be acknowledged and the advertisement can be rendered on the IPTV viewing device (signal 8 and step 9, respectively), e.g., in a separate viewing window relative to the ongoing IPTV program.

The foregoing exemplary embodiments illustrate a mechanism for providing advertisements to an IPTV end user/client device via an IMS network which involves sending a SUBSCRIBE message by the ad server 24 to the registration event package, however the present invention is not so limited. Other IMS functions can be used to provide the ad server 24 with information which can be used to determine when to forward advertisements to the target user(s) through the IMS/IP network. For example, the ad server 24 could alternatively (or additionally) SUBSCRIBE to the user presence, in which case the presence server (not shown) handles this subscription. Through that subscription, the ad server 24 learns about the target user(s) reachability. For example, the ad server 24 may want to send an audio ad, in which case it can call an appropriate contact in the presence information for that user.

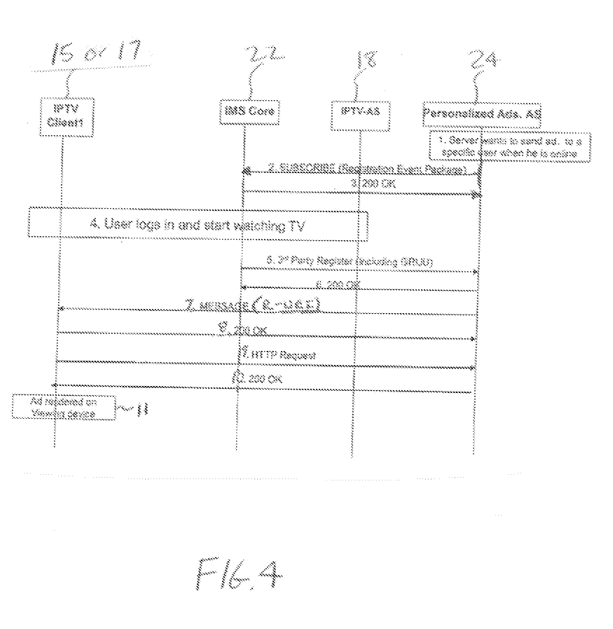

As an alternative to sending text advertisements directly within SIP signaling, as discussed in the foregoing exemplary embodiment of FIG. 3, other exemplary embodiments provide for an HTTP URI to be sent in the SIP message. This approach could be taken if, for example, an advertisement was too large to send directly in a single SIP message. As shown in the signaling diagram of FIG. 4, wherein steps/messages 1-8 are the same as described above with respect to FIG. 3, after learning that a personalized advertisement is available, the IPTV client 15 or 17 sends an HTTP request message (signal 9) using the R-URI provided in the SIP message (signal 7) to obtain the advertising content. This HTTP request can also be acknowledged (signal 10) and the advertising content displayed on the IPTV device (step 11 in FIG. 4), e.g., via the web page or JAVA script which was fetched via the HTTP request.

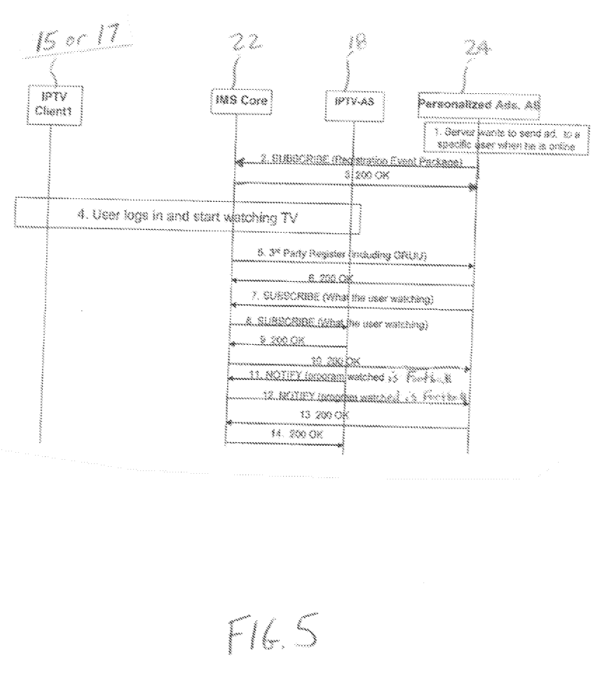

According to yet another exemplary embodiment, the ad server 24 may want to target specific times to send personalized advertisements rather than reacting to the presence of the targeted user being online. For example, the ad server 24 may want to send certain ads only when the user is (or is not) watching certain television programs. According to this exemplary embodiment, the ad server 24 can subscribe, via the IPTV application server 18, to a service which informs the ad server 24 about the specific program which a targeted user is watching and the ad server 24 can then use that information to determine when, or whether, to send a personalized advertisement to that user's equipment. An exemplary signaling flow associated with this exemplary embodiment is shown in FIG. 5.

Therein, signals/steps 1-6 are the same as those described above with respect to FIGS. 3 and 4. However, after signal 6, the ad server 24 sends a SUBSCRIBE message to the “what the user is watching” event package to the IMS core 22. In turn, at signal 8, the IMS core 22 sends a SUBSCRIBE message to the IPTV application server 18 to request this information. Acknowledgements (signals 9 and 10) are transmitted back to the IMS core 22 and ad server 24, respectively. The IPTV application server 18 then sends a NOTIFY message to the IMS core 22 which provides identification information regarding the IPTV program which is being watched by the end user targeted for an advertisement by ad server 24 (signal 11). A corresponding NOTIFY signal (signal 12) is sent from the IMS core 22 to the ad server 24 to provide this program identification information. Acknowledgement signals indicating that the NOTIFY messages were received by the ad server 24 and IMS core 22 are sent as signals 13 and 14, respectively. In this example, the ad server 24 decides that it does not want to interrupt the targeted user's viewing of the particular program which is identified in the NOTIFY message and, accordingly, does not forward the advertisement to the IPTV client 15 or 17 at this time.

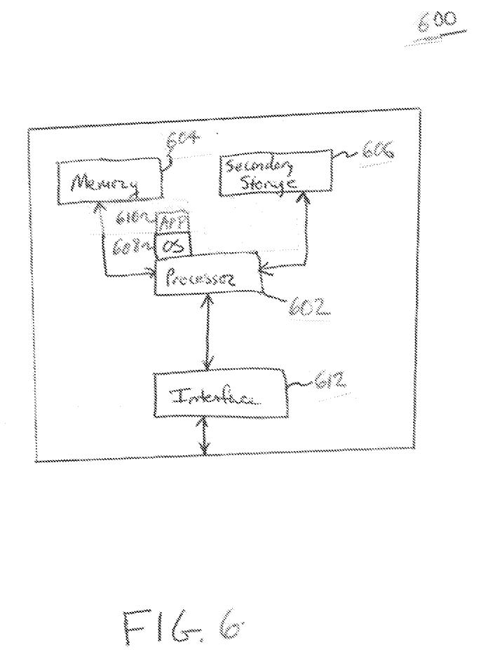

The exemplary embodiments described above provide for messages and protocols involving ad servers and other network nodes. An exemplary ad server 600 will now be described with respect to FIG. 6. Ad server 600 can contain a processor 602 (or multiple processor cores), memory 604, one or more secondary storage devices 606 and an interface unit 608 to facilitate communications between ad server 600 and the rest of the network. The processor 602 can run an operating system and an application, e.g., an ad server selection application, thereon. The memory can be used for storage of exemplary items described above such as the advertisements or references (e.g., links, URIs) to advertisements. Similar server structures can also be used for other network nodes described above, e.g., the IMS core network entities.

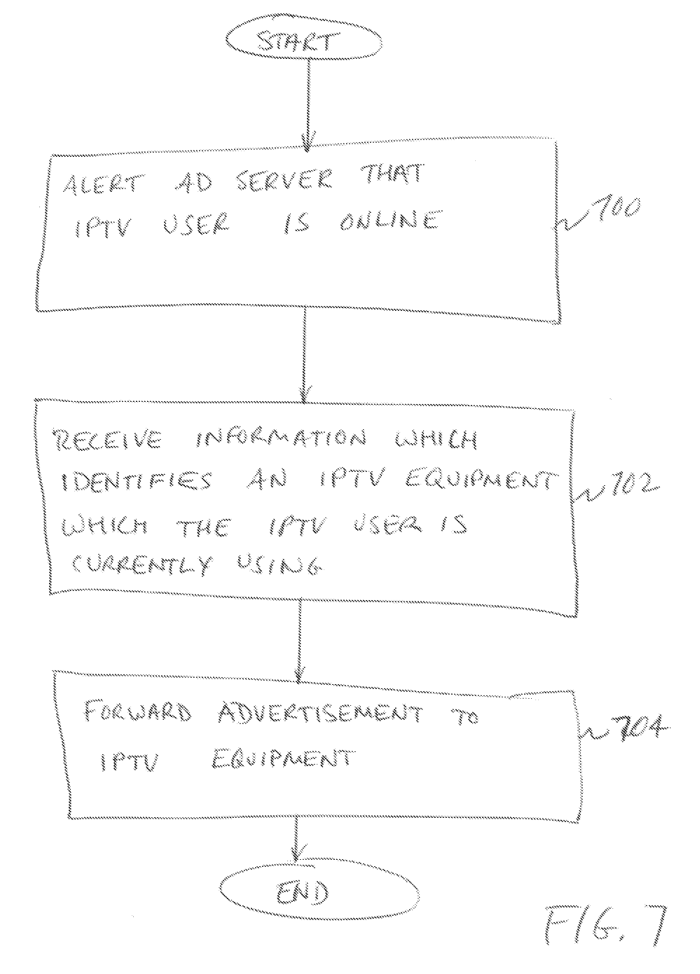

Some specific, yet purely exemplary, methods for providing advertisements are detailed above. A more general method for providing advertisements from an ad server to an IPTV end user via an IMS network according to these exemplary embodiments includes the steps illustrated in the flowchart of FIG. 7. Therein, at step 700, an ad server is alerted when a particular IPTV end user or a group of users (to which the ad server desires to send an ad) is online. The ad server receives, at step 702, information (e.g., a GRUU) which identifies an IPTV equipment which that IPTV end user is currently using. In response, the ad server forwards an advertisement selected for said IPTV end user to said IPTV equipment at step 704. This latter step may either involve a direct forwarding of the advertisement text, or an indirect forwarding of the advertisement by, for example, sending a reference or link to the location of the advertisement.

Systems and methods for processing data according to exemplary embodiments of the present invention can be performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above. In alternative embodiments, hardwire circuitry may be used in place of or in combination with software instructions to implement the present invention.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A method for providing advertisements from an ad server to an IPTV end user via an IMS network comprising:
alerting said ad server when said IPTV end user is online;
receiving, at said ad server, information which identifies an IPTV equipment which said IPTV end user is currently using; and
forwarding, in response to said alert and said information, an advertisement selected for said IPTV end user to said IPTV equipment.

2. The method of claim 1, further comprising:
subscribing, by said ad server, to an alert service which sends said alert to said ad server when said IPTV end user is online.

3. The method of claim 2, wherein said step of subscribing further comprises:
receiving, at a serving call service control function (S-CSCF) entity, a subscription message from said ad server.

4. The method of claim 1, wherein said step of receiving further comprises:
receiving, at said ad server, a globally routable user agent URI (GRUU) via a SIP message.

5. The method of claim 4, wherein said step of providing said ad server with said GRUU further comprises:
transmitting, from a serving call service control function (S-CSCF) entity, said SIP message.

6. The method of claim 1, wherein said step of forwarding, in response to said alert and said information, an advertisement selected for said IPTV end user to said IPTV equipment further comprises:
forwarding said advertisement in text form to said IPTV equipment.

7. The method of claim 1, wherein said step of forwarding, in response to said alert and said information, an advertisement selected for said IPTV end user to said IPTV equipment further comprises:
forwarding an HTTP URI to said IPTV equipment;
receiving an HTTP request with said HTTP URI from said IPTV equipment; and
supplying said advertisement to said IPTV equipment in response to said HTTP request.

8. The method of claim 1, further comprising:
subscribing, by said ad server, to a service which provides said ad server with information regarding which IPTV program said end user is currently watching.

9. The method of claim 9, further comprising:
determining, by said ad server, when to forward said advertisement based on said information regarding which IPTV program said end user is currently watching.

10. A communication system comprising:
an ad server including:
a processor for receiving an alert indicating when an IPTV end user is online and information which identifies an IPTV equipment which said IPTV end user is currently using; and
a memory device for storing one of: an advertisement for said IPTV end user and a reference to said advertisement;
wherein said processor forwards, in response to said alert and said information, one of said advertisement and said reference to said IPTV equipment.

11. The communication system of claim 10, wherein said ad server subscribes to an alert service which sends said alert to said ad server when said IPTV end user is online.

12. The communication system of claim 11, further comprising:
a serving call service control function (S-CSCF) entity which receives a subscription message from said ad server.

13. The communication system of claim 10, wherein said processor receives, as said information which identifies said IPTV equipment, a globally routable user agent URI (GRUU) via a SIP message.

14. The communication system of claim 13, further comprising:
a serving call service control function (S-CSCF) entity which transmits said SIP message.

15. The communication system of claim 10, wherein said processor forwards said advertisement in text form to said IPTV equipment.

16. The communication system of claim 10, wherein said processor forwards as said reference an HTTP URI to said IPTV equipment, receives an HTTP request with said HTTP URI from said IPTV equipment, and supplies said advertisement to said IPTV equipment in response to said HTTP request.

17. The communication system of claim 10, where said ad server subscribes, to a service which provides said ad server with information regarding which IPTV program said end user is currently watching.

18. The communication system of claim 17, wherein said ad server determines when to forward said advertisement based on said information regarding which IPTV program said end user is currently watching.

19. The communication system of claim 10 further comprising:
an IMS core network connected to said ad server and an IPTV application server;
an IP core network connected to said IMS core network; and
at least one IPTV end user device connected to said IP core network.

20. A computer-readable medium containing instructions which, when executed on a computer, perform the steps of:
alerting an ad server when an IPTV end user is online;
receiving, at said ad server, information which identifies an IPTV equipment which said IPTV end user is currently using; and
forwarding, in response to said alert and said information, an advertisement selected for said IPTV end user to said IPTV equipment.

21. The method of claim 2, wherein said alert service is one of: a registration event package and a presence package.

22. The communication system of claim 11, wherein said alert service is one of: a registration event package and a presence package.
